(19) United States
(12) Patent Application Publication
(10) Pub. No.: US 2021/0181054 A1
(43) Pub. Date: Jun. 17, 2021

(54) LEAK-TIGHTNESS TESTING OF MOTOR VEHICLE BODIES

(71) Applicant: Karl Wörwag Lack- und Farbenfabrik GmbH & Co. KG, Korntal-Münchingen (DE)

(72) Inventors: Christian Bischoff, Remlingen (DE); Ralf Sauer, Waiblingen (DE); Manuel Seibold, Kernen i.R. (DE)

(21) Appl. No.: 17/271,325

(22) PCT Filed: Aug. 21, 2019
(86) PCT No.: PCT/EP2019/072407

§ 371 Date: Feb. 25, 2021

(30) Foreign Application Priority Data
Aug. 28, 2018 (DE) 10 2018 214 554.7

(51) Int. Cl. G01M 3/16; B62D 65/00; G01M 17/00

(52) U.S. Cl. CPC G01M 3/165; G01M 17/00; B62D 65/005

(57) ABSTRACT

A method of leak-tightness testing a motor vehicle body that includes: a. fitting of electrically conductive contacts to at least one inner side of the motor vehicle body, and b. applying an electrical voltage between the contacts, c. applying water to at least a portion of at least one outer side of the motor vehicle body, and d. monitoring the voltage applied between the contacts to detect any drop in voltage that may occur, wherein at least one of the electrically conductive contacts comprises a lacquer composition comprising an organic binder and at least one electrically conductive additive.

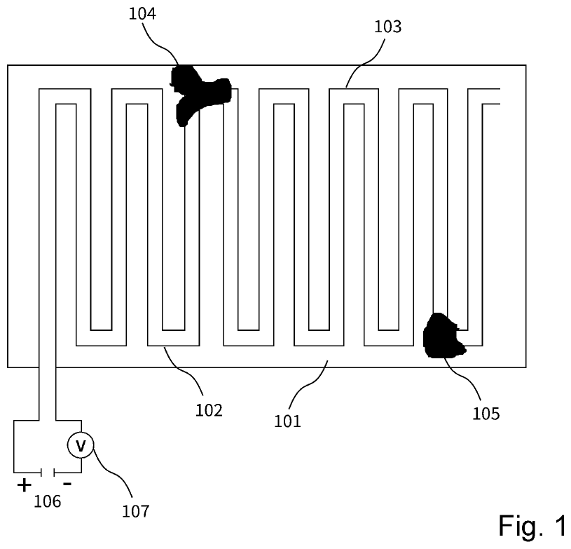

### TECHNICAL FIELD

This disclosure relates to a method for the leak-tightness testing of a motor vehicle body, and a motor vehicle body having an appropriate test apparatus.

### BACKGROUND

In current vehicle production, at the end of assembly, at least a sample of assembled vehicle bodies undergo a “rainwater leak-tightness test.” This involves sprinkling by an automatic sprinkler system and a subsequent control for the establishment of any penetration of water into the vehicle body thus sprinkled. Leak-tightness control (for the penetration of water) can be executed visually and manually. However, approaches also exist for the automatic detection of water penetration.

GB 1 535 047 tests the leak-tightness of vehicle windows. The method is based upon measurement of a current flowing between two electrodes in the event of the penetration of a fluid. The electrodes are not specified in greater detail.

DE 196 16 223 A1 discloses an ultrasound-based device for the leak-tightness testing of motor vehicles.

DE 198 150 62 C2 discloses detection of the penetration of water into a vehicle body a capacitance measurement. To this end, an electrically-conductive layer is arranged within the vehicle body. The layer and the vehicle underfloor can function as the poles of a capacitor. In the event of the penetration of water between the layer and the vehicle body, the electric field between these poles varies. The resulting variation in capacitance can be correspondingly employed as an indicator of the penetration of water.

From practice, it is known for two parallel electrical copper strip conductors to be provided on the inner side of the vehicle body underfloor, and a voltage to be applied between the strip conductors. If, during leak-tightness testing, water penetrates the vehicle body and connects the parallel strip conductors, a voltage drop will be observed. This voltage drop can be employed as a qualitative indicator of the penetration of water.

The measures described are, in some instances, highly complex such that, for example, it is generally necessary for the above-mentioned electrical copper strip conductors to be arranged manually in the vehicle body. Moreover, the above-mentioned methods generally permit only a qualitative conclusion to be drawn with regard to the potential penetration of water. It would be more expedient if, with no additional measures, it were also possible to obtain exact information on the location of the water penetration.

It could therefore be helpful to provide an improved method for the leak-tightness testing of a motor vehicle body.

### SUMMARY

We provide a method of leak-tightness testing a motor vehicle body including fitting electrically conductive contacts to at least one inner side of the motor vehicle body, and applying an electrical voltage between the contacts, applying water to at least a pattern of at least one outer side of the motor vehicle body, and monitoring the voltage applied between the contacts to any drop in voltage that may occur, wherein at least one of the electrically conductive contacts includes a lacquer composition including an organic binder and at least one electrically conductive additive.

We also provide a motor vehicle body including a plurality of electrical contacts on an inner side thereof, and at least one of the plurality of contacts includes a lacquer composition including an organic binder and at least one electrically conductive additive.

### BRIEF DESCRIPTION OF THE DRAWING

The FIGURE schematically shows a plan view of the inner side of a floor panel of a motor vehicle according to an example.

### DETAILED DESCRIPTION

Our method comprises the four directly following steps a. to d.:

a. fitting electrically conductive contacts to at least one inner side of the motor vehicle body which is to be tested for leak-tightness,
b. application of an electrical voltage between the contacts,
c. application of water to at least one outer side of the motor vehicle body, and
d. monitoring the voltage applied between the contacts to detect any drop in voltage that may occur.

The method is particularly characterized by the following additional step e.:

e. at least one of the electrically conductive contacts is constituted of a lacquer composition that, in addition to an organic binder, contains a proportion of at least one electrically conductive additive.

The method permits testing of a motor vehicle body for any penetration of water using very simple means, and with only a very limited expenditure of time. In particular, the method further permits determination of the location where water has penetrated the vehicle body. This is achieved wherein, although conductive contacts formed of the lacquer composition have an electrical conductivity, the latter, by a substantial margin, is not so high as the electrical conductivity of strip conductors comprised of a metallic material such as copper. This characteristic can be exploited, as further described hereinafter.

Particularly preferably, the method is additionally characterized by at least one of the directly following additional steps and/or features a. to c.:

a. the lacquer composition comprises, by way of an electrically conductive additive, an electrically conductive carbon modification,
b. the carbon modification comprises carbon black, graphite, graphene or carbon nanotubes,
c. the lacquer composition comprises, by way of an electrically conductive additive, a metallic powder, and
d. the lacquer composition comprises an electrically conductive polymer, particularly by way of the electrically conductive additive, for example, poly-3,4-ethylenedioxythiophene (PEDOT) or polyaniline (PAni) or polypyrrole (PPy).

Carbon black is particularly preferred as an electrically conductive additive.

Further particularly preferably, the method is additionally characterized by at least one of the directly following additional features a. to c.:

a. the carbon modification is carbon black or graphite added to the lacquer composition in a fraction of 5 to 80% by weight as a proportion of the solids content of the lacquer composition,
b. the carbon modification is carbon black or graphite added to the lacquer composition in a fraction of 5 to 50% by weight as a proportion of the solids content of the lacquer composition, and
c. the carbon modification is carbon black or graphite added to the lacquer composition in a fraction of 5 to 25% by weight as a proportion of the solids content of the lacquer composition.

Electrically conductive contacts are achieved, the electrical conductivity of which is lower than the specific electrical conductivity of the carbon black or graphite employed. Feature c. specified immediately above is particularly preferred.

Further particularly preferably, the method is additionally characterized by the directly following additional feature a.:

a. the electrically conductive additive is added to the lacquer composition in such a quantity that the at least one strip conductor is constituted having a specific electrical resistance of 100 Ω*mm²/m to 5*10⁵ Ω*mm²/m (at 20° C.).

The requisite quantity of additive can be determined in a problem-free manner by tests.

For application of the electrical voltage, the electrically conductive contacts can be connected to an arbitrary voltage source. It is particularly preferred, however, that the voltage source, in the same way as the electrical contacts, is applied to the at least one inner side.

The voltage source can, for example, be an electrochemical cell in which electrical energy has been statically or electrochemically stored, particularly a printed electrochemical cell. The printing of electrochemical cells constitutes state-of-the-art practice. Thus, for example, negative electrodes comprising zinc particles and positive electrodes comprising manganese dioxide particles can be printed next to one another on the at least one inner side, and interconnected by an electrolyte. Ideally, the negative electrode is printed directly onto one of the electrically conductive contacts, and the positive electrode is printed directly onto the other of the electrically conductive contacts such that a current flows if the contacts are electrically interconnected.

Alternatively, it is also possible for an electrical component to be employed as a voltage source, particularly a coil in which an electrical voltage can be induced under the influence of a magnetic field.

Furthermore, it is preferred that the electrically conductive contacts themselves incorporate a structure or a substructure in which an electrical voltage can be induced. No separate voltage source is then required for application of the electrical voltage between the contacts.

Further particularly preferably, the method is additionally characterized by the directly following additional feature a.:

a. the lacquer composition, by way of an organic binder, comprises a polyurethane-based binder.

Naturally, other binders can also be employed. The choice of binder is not particularly critical.

In a number of preferred configurations, it is preferred that the at least one inner side, if it is not already configured as electrically insulating prior to the application of the electrically conductive contacts, should be covered with an electrically insulating lacquer coating, at least in those areas in which the electrically conductive contacts are to be applied. It is particularly preferred that the electrically insulating lacquer coating is applied by printing.

Any motor vehicle body that can be tested for leak-tightness by the above-mentioned method is also included in the scope of this disclosure. Motor vehicle bodies are characterized by the following features:

a. they incorporate electrical contacts on an inner side, and
b. at least one of the contacts is constituted of the above-mentioned lacquer composition containing, in addition to an organic binder, a proportion of at least one electrically conductive additive.

A number of preferred configurations of the electrical contacts, and the production thereof, in particular in relation to the composition thereof, have already been described in conjunction with the method. To avoid repetition, it is simply indicated at this point that reference should be made to these preferred forms.

Particularly preferably, the motor vehicle body is additionally characterized by one of the directly following additional features a. to d.:

a. the inner side having the electrical contacts is coated with an electrically insulating lacquer upon which the electrical contacts are arranged,
b. the electrical contacts are provided in the form of parallel strip conductors,
c. the parallel strip conductors are arranged with an average spacing from one another of 1 mm to 10 cm, preferably 5 mm to 10 cm, and
d. the parallel strip conductors have a respective length of 10 cm to 100 m, preferably 1 m to 10 m.

It is particularly preferred that at least features a. and b., and preferably even features a. to d., are executed in combination.

Further particularly preferably, the motor vehicle body is additionally characterized by the directly following additional feature a.:

a. the inner side having the electrical contacts is the underfloor of the motor vehicle body.

According to the above-mentioned configurations, it can be preferred that the motor vehicle body comprises a voltage source electrically connected to the electrical contacts on the inner side. This voltage source can particularly be an electrochemical cell in which electrical energy has been statically or electrochemically stored, or an electrical component, particularly a coil in which an electrical voltage can be induced under the influence of a magnetic field. Alternatively, the electrically conductive contacts themselves can incorporate a structure or a substructure in which an electrical voltage can be induced.

### Examples

Further features, details and advantages proceed from the claims and the abstract, the wording of both of which refers to the content of this disclosure, and from the following description of a preferred example, with reference to the drawing.

Two mutually parallel-oriented strip conductors 102 and 103 are applied to the floor panel 101 of a motor vehicle body, on the inner side thereof. The two strip conductors are respectively constituted of a lacquer composition containing, in addition to a polyurethane-based binder, a proportion of conductive carbon black by way of an electrically conductive additive. The strip conductors are applied in a width of approximately 5 mm. The average spacing between the strip conductors is 5 mm.

The constitution of the lacquer composition is:

| | |
|---|---|
| Water (desalinated) | 34% by weight |
| Aqueous polyurethane acrylate dispersion with a solids | 30% by weight |
| content of 40% | |
| Filler (titanium dioxide) | 20% by weight |
| Conductive carbon black with a specific surface area | 4.5% by weight |
| of 65 m²/g (nitrogen surface area (ASTM D-3037-89)) | |
| Additive mixture (rheological additive, anti-foaming | 11.5% by weight |
| agent, dispersant, substrate cross-linking additive) | |

The strip conductors 102 and 103 thus constituted have an electrical conductivity. However, the conductivity is lower, by some orders of magnitude, than that of electrical conductors such as copper. If the two strip conductors 102 and 103 are electrically interconnected, the location of the connection can be estimated by a voltage measurement, as the voltage drop observed compared to copper is far more substantially dependent upon the respective length of the strip conductors.

For detection of water penetration, the strip conductor 102 is connected to the negative pole and the strip conductor 103 to the positive pole of the voltage source 106. The voltage applied between the strip conductors is monitored by the voltage measuring device 107. Immediately, as a consequence of water penetration, the strip conductor 102 and the strip conductor 103 are electrically interconnected, for example, by the water puddle 104 or the water puddle 105, a voltage drop will be observed. The remaining residual voltage can deliver information as to the distance from the voltage source at which the strip conductors have been interconnected. Thus, in the event of the puddle 104 and/or the puddle 105, voltage drops of different magnitudes will be observed, as the length of the conductor sections of the strip conductors 102 and 102 between the poles of the voltage source and the puddle 104 is significantly smaller than between the poles of the voltage source and the puddle 105.

In copper, a differential voltage drop would scarcely be measurable. The specific conductivity of copper is sufficiently high such that the length of the strip conductors has barely any influence upon the magnitude thereof.

1.-8. (canceled)

9. A method of leak-tightness testing a motor vehicle body comprising:
a. fitting electrically conductive contacts to at least one inner side of the motor vehicle body, and
b. applying an electrical voltage between the contacts,
c. applying water to at least a portion of at least one outer side of the motor vehicle body, and
d. monitoring the voltage applied between the contacts to detect any drop in voltage that may occur,
wherein at least one of the electrically conductive contacts comprises a lacquer composition comprising an organic binder and at least one electrically conductive additive.

10. The method as claimed in claim 9, wherein at least one of:
a. the lacquer composition comprises, by the electrically conductive additive, an electrically conductive carbon modification,
b. the carbon modification comprises carbon black, graphite, graphene or carbon nanotubes,
c. the lacquer composition comprises, by the electrically conductive additive, a metallic powder, and
d. the lacquer composition comprises an electrically conductive polymer.

11. The method as claimed in claim 9, wherein at least one of:
a. the carbon modification is carbon black or graphite added to the lacquer composition in a fraction of 5 to 80% by weight based on the amount of the solids content of the lacquer composition,
b. the carbon modification is carbon black or graphite added to the lacquer composition in a fraction of 5 to 50% by weight based on the amount of the solids content of the lacquer composition,
c. the carbon modification is carbon black or graphite based on the amount added to the lacquer composition in a fraction of 5 to 25% by weight of the solids content of the lacquer composition.

12. The method as claimed in claim 9, wherein the electrically conductive additive is added to the lacquer composition in an amount such that the at least one strip conductor is constituted having a specific electrical resistance of 100 Ω*mm²/m to 5*10⁵ Ω*mm²/m (at 20° C.).

13. The method as claimed in claim 9, wherein the lacquer composition, by the organic binder, comprises a polyurethane-based binder.

14. A motor vehicle body comprising:
a. a plurality of electrical contacts on an inner side thereof, and
b. at least one of the plurality of contacts comprises a lacquer composition comprising an organic binder and at least one electrically conductive additive.

15. The motor vehicle body as claimed in claim 14, having at least one of:
a. the inner side is coated with the lacquer composition, upon which the electrical contacts are arranged,
b. the electrical contacts are parallel strip conductors,
c. the parallel strip conductors are arranged with an average spacing from one another of 1 mm to 10 cm, and
d. the parallel strip conductors have a respective length of 10 cm to 100 m.

16. The motor vehicle body as claimed in claim 14, wherein the inner side is an underfloor of the motor vehicle body.
